(19) United States
(12) Patent Application Publication
(10) Pub. No.: US 2014/0351303 A1
(43) Pub. Date: Nov. 27, 2014

(54) APPARATUS AND METHOD FOR ACQUIRING NOISE SOURCE ENTROPY FOR RANDOM NUMBER GENERATOR

(71) Applicant: ELECTRONICS AND TELECOMMUNICATIONS RESEARCH INSTITUTE, Daejeon (KR)

(72) Inventors: Seon-yeong PARK, Daejeon (KR); Hyuk Joong YOON, Daejeon (KR); Sang Yun HAN, Daejeon (KR); Jong Tai LEE, Daejeon (KR); Hee Bong CHOI, Daejeon (KR); Sangwoo PARK, Daejeon (KR)

(73) Assignee: ELECTRONICS AND TELECOMMUNICATIONS RESEARCH INSTITUTE, Daejeon (KR)

(21) Appl. No.: 14/135,162

(22) Filed: Dec. 19, 2013

(30) Foreign Application Priority Data
May 27, 2013 (KR) 10-2013-0059836

(51) Int. Cl. G06F 7/58

(52) U.S. Cl. CPC G06F 7/588
USPC 708/250

(57) ABSTRACT

The present invention relates to an apparatus and method for acquiring noise source entropy for a random number generator, which use contention for access to memory between Graphical Processing Unit (GPU) cores. For this, an apparatus for acquiring noise source entropy for a random number generator includes a core calling unit for simultaneously calling a plurality of cores to a critical area, and a noise source entropy generation unit for generating noise source entropy based on a sequence of entry of the plurality of cores into the critical area.

### CROSS REFERENCE TO RELATED APPLICATION

This application claims the benefit of Korean Patent Application No. 10-2013-0059836 filed on May 27, 2013, which is hereby incorporated by reference in its entirety into this application.

### BACKGROUND OF THE INVENTION

1. Technical Field

The present invention relates generally to an apparatus and method for acquiring noise source entropy for a random number generator and, more particularly, to an apparatus and method for acquiring noise source entropy for a random number generator, which use contention for memory access between Graphical Processing Unit (GPU) cores.

2. Description of the Related Art

Random numbers used in encryption algorithms are generally generated by a random number generator. In this case, random numbers must be unpredictable, unbiased, and independent, but it is difficult to generate perfect cryptographic random numbers satisfying all characteristics. Therefore, a random number generator for inputting a seed to a deterministic random number generator and generating a pseudo random number has been widely used.

In this case, a seed is a bit stream used as the input of the deterministic random number generator. Further, a random number sequence output from the deterministic random number generator is determined by the input, that is, the seed, into the random number generator. Accordingly, the security of the random number sequence output from the random number generator depends on the seed. Even if a deterministic random number generator which statistically secures excellent randomness is used, an output random number is a predictable number sequence if the entropy of an input seed is limited, and only security below the entropy of the seed may be guaranteed.

Generally, the generation of a seed is externally performed on the outside of the random number generator. In a typical Personal Computer (PC) environment, a noise source provided by an operating system is used as the seed of the random number generator. Depending on the collection period of noise sources, entropy is greatly variable and the types of noise sources that can be collected are restrictive. Therefore, if a sound noise source is additionally secured, the security of the random number generator can be strengthened. Further, a noise source can generate a secure seed only when statistical characteristics thereof are obtained as results approximate to a normal distribution.

In relation to this, there is technology disclosed in Korean Patent Application Publication No. 2011-0029164 entitled “Adaptive generation of the seed of a pseudo random number generator.”

### SUMMARY OF THE INVENTION

Accordingly, the present invention has been made keeping in mind the above problems occurring in the prior art, and an object of the present invention is to provide an apparatus and method for acquiring noise source entropy for a random number generator, which can acquire sound noise source entropy.

In accordance with an aspect of the present invention to accomplish the above object, there is provided an apparatus for acquiring noise source entropy for a random number generator, including a core calling unit for simultaneously calling a plurality of cores to a critical area; and a noise source entropy generation unit for generating noise source entropy based on a sequence of entry of the plurality of cores into the critical area.

Preferably, the plurality of cores may be cores included in a Graphical Processing Unit (GPU).

Preferably, the noise source entropy generation unit may be configured to, if any one of the plurality of cores enters the critical area, prevent entry of remaining cores into the critical area.

Preferably, the noise source entropy generation unit may be configured to, if the core that entered the critical area leaves the critical area, release prevention of entry into the critical area.

Preferably, the noise source entropy generation unit may use a busy waiting lock technique for selecting any one from among the remaining cores, entry of which is prevented, and causing the selected core to enter the critical area when prevention of entry into the critical area is released.

Preferably, the busy waiting lock technique may be repeated until a number of cores to enter the critical area becomes 0.

Preferably, the noise source entropy generation unit may be configured to store respective identifiers of the plurality of cores in a storage unit in a sequence of entry of the cores into the critical area, and generate the noise source entropy based on the identifiers stored in the sequence of entry of the cores into the critical area.

Preferably, the critical area may be formed in memory used by the GPU.

In accordance with another aspect of the present invention to accomplish the above object, there is provided a method of acquiring noise source entropy for a random number generator, including simultaneously calling, by a core calling unit, a plurality of cores to a critical area; and generating, by a noise source entropy generation unit, noise source entropy based on a sequence of entry of the plurality of cores into the critical area.

Preferably, the plurality of cores may be cores included in a Graphical Processing Unit (GPU).

Preferably, generating the noise source entropy may be configured to, if any one of the plurality of cores enters the critical area, prevent entry of remaining cores into the critical area.

Preferably, generating the noise source entropy may be configured to, if the core that entered the critical area leaves the critical area, release prevention of entry into the critical area.

Preferably, generating the noise source entropy may be performed using a busy waiting lock technique for selecting any one from among the remaining cores, entry of which is prevented, and for causing the selected core to enter the critical area when prevention of entry into the critical area is released.

Preferably, the busy waiting lock technique may be repeated until a number of cores to enter the critical area becomes 0.

Preferably, generating the noise source entropy may be configured to store respective identifiers of the plurality of cores in a storage unit in a sequence of entry of the cores into the critical area, and generate the noise source entropy based on the identifiers stored in the sequence of entry of the cores into the critical area.

Preferably, the critical area may be formed in memory used by the GPU.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a random number generator to which an apparatus for acquiring noise source entropy according to the present invention is applied;

FIG. 2 is a block diagram showing an apparatus for acquiring noise source entropy according to an embodiment of the present invention;

FIG. 3 is an operation flowchart showing a method of acquiring noise source entropy according to an embodiment of the present invention; and

FIG. 4 is a diagram showing code for implementing the noise source entropy acquisition method according to the present invention in the form of a program.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

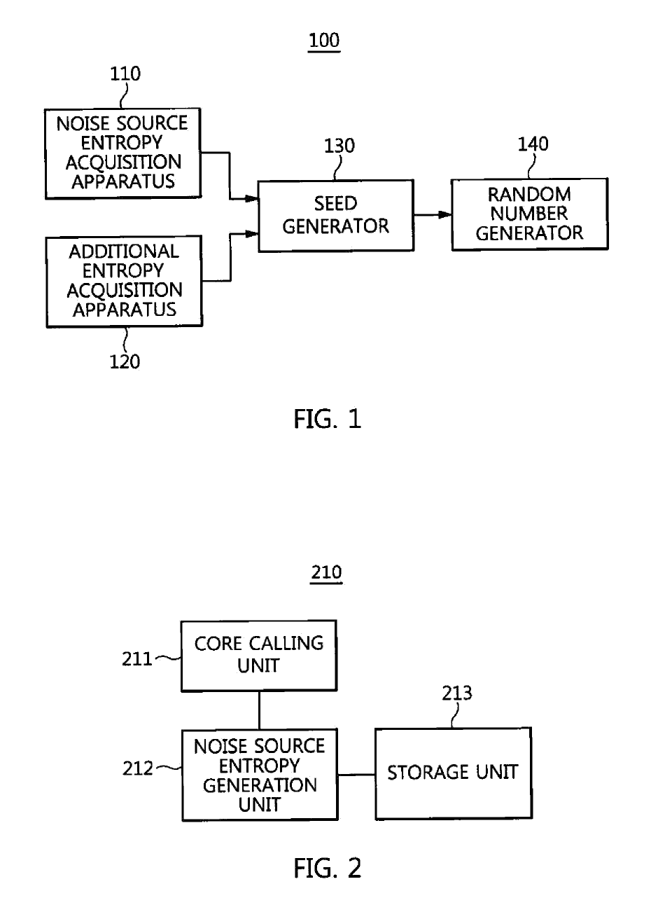

FIG. 1 is a block diagram showing a random number generator to which an apparatus for acquiring noise source entropy according to the present invention is applied. Referring to FIG. 1, a noise source entropy acquisition apparatus 110 according to the present invention, an additional entropy acquisition apparatus 120, a seed generator 130, and a random number generator 140 are shown. The components required to generate random numbers may be chiefly divided into nondeterministic components and deterministic components. As described above, the security of the random number generator 140 which is the deterministic component is based on the acquisition of sound noise source entropy by the nondeterministic components, such as the noise source entropy acquisition apparatus 110, the additional entropy acquisition apparatus 120, and the seed generator 130 which generate a seed.

The noise source entropy acquisition apparatus 110 induces a plurality of cores of a Graphical Processing Unit (GPU) to contend for access to memory used by the GPU, and uses the sequence of the GPU cores, obtained as a result of the contention, as a noise source. Since the apparatus 110 will be described in detail later with reference to FIG. 2, a detailed description thereof will be omitted here.

The additional entropy acquisition apparatus 120 denotes a device for generating entropy using a method other than that of the noise source entropy acquisition apparatus 110.

The seed generator 130 may generate a seed using noise source entropy output from the noise source entropy acquisition apparatus 110 according to the present invention and additional entropy output from the additional entropy acquisition apparatus 120. In this case, a more robust seed may be formed due to the features of the noise source entropy acquired by contention for access to the memory of the GPU. Further, the seed generator 130 may generate a seed via post-processing by combining the noise source entropy with the additional entropy acquired using the additional method.

FIG. 2 is a block diagram showing the noise source entropy acquisition apparatus shown in FIG. 1.

As, described above, a noise source entropy acquisition apparatus 210 functions to induce a plurality of cores of a GPU to contend for access to memory used by the GPU, and to use the sequence of the GPU cores, obtained as a result of the contention, as a noise source, as described above with reference to FIG. 1. As shown in FIG. 2, the noise source entropy acquisition apparatus 210 according to the present invention includes a core calling unit 211, a noise source entropy generation unit 212, and a storage unit 213. Below, the individual components included in the noise source entropy acquisition apparatus 210 according to the present invention will be described in detail.

The core calling unit 211 functions to simultaneously call the plurality of cores to a critical area. That is, the core calling unit 211 functions to allow the plurality of cores to simultaneously access the critical area. Here, the cores denote cores included in the GPU. Further, the critical area denotes an area formed in the memory used by the GPU. That is, the critical area denotes a partial area allocated to the memory used by the GPU. Furthermore, the critical area is a mutual exclusion region, as will be described later. Accordingly, only a single GPU core may enter the critical area at a time. As described above, the noise source entropy acquisition apparatus 210 according to the present invention uses a scheme for contending for access to the memory. Accordingly, the core calling unit 211 calls the plurality of cores to the critical area, thus allowing the cores to be simultaneously operated.

The noise source entropy generation unit 212 functions to generate noise source entropy based on the sequence of entry of the plurality of cores into the critical area. Here, when any one of the cores enters the critical area, the noise source entropy generation unit 212 prevents the remaining cores from entering the critical area. Further, if the core that entered the critical area leaves the critical area, the noise source entropy generation unit 212 releases the prevention of entry of the remaining cores into the critical area. In this way, only a single core may enter the critical area. By way of this operation, a plurality of cores are prevented from simultaneously entering the critical area, and thus error may be reduced upon determining the sequence of entry of the cores.

Furthermore, the noise source entropy generation unit 212 uses a busy waiting lock technique for selecting any one of the remaining cores, the entry of which has been prevented, and for causing the selected core to enter the critical area when the prevention of entry into the critical area is released. That is, when a method for waiting for a GPU core which previously entered the critical area is put to sleep, a scheduler assigns priorities to specific cores. In this case, depending on the priorities set by the scheduler, a GPU core to enter the critical area is determined. Therefore, the method using sleep may cause a problem in variously and randomly forming noise sources, and thus this method must be avoided.

In contrast, if the busy waiting lock technique proposed in the present invention is used, an advantage is obtained in that noise sources may be formed to be more robust to external attacks, more various, and more secure by using the characteristics of randomly selecting any one from among the remaining cores rather than using priorities.

Furthermore, the noise source entropy generation unit 212 may repeat the above-described busy waiting lock technique. That is, the noise source entropy generation unit 212 may determine whether cores to enter the critical area are present, and repeat the busy waiting lock technique so that all cores pass through the critical area, that is, until the number of cores to enter the critical area becomes ‘0’.

In this way, the noise source entropy generation unit 212 repeats the above procedures, and generates noise source entropy based on the sequence of entry of the plurality of cores into the critical area if all of the cores pass through the critical area. In detail, the noise source entropy generation unit 212 may store respective identifiers of the plurality of cores in the storage unit 213 in the sequence of entry of the cores into the critical area whenever each of the cores enters the critical area or after all of the cores have entered the critical area. By way of this, the noise source entropy generation unit 212 may generate noise source entropy using the identifiers aligned in the sequence of entry into the critical area.

In this way, the noise source entropy acquisition apparatus 210 of the present invention uses the identifiers of the GPU cores obtained as a result of contention for access to the memory. Therefore, if the probability of individual cores of the GPU entering the critical area is assumed to be uniform, it may be assumed that Bernoulli trials are repeated. Due to this fact, a noise source, the distribution of which is approximate to a normal distribution may be generated.

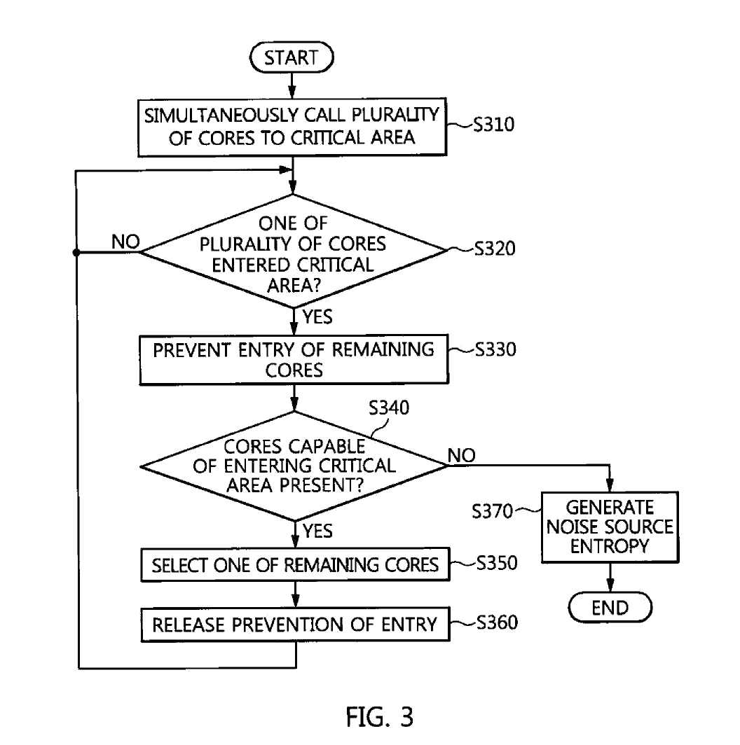

FIG. 3 is an operation flowchart showing a method of acquiring noise source entropy according to an embodiment of the present invention. Below, a description of components previously described with reference to FIGS. 1 and 2 will be omitted for the simplicity of the present specification.

First, by the core calling unit, a plurality of cores are simultaneously called to the critical area at step S310. Using step S310, the plurality of cores simultaneously access the critical area. As described above, the cores denote cores included in the GPU, and the critical area denotes an area formed in memory used by the GPU, that is, a partial area allocated to the memory used by the GPU. Further, since the critical area is a mutual exclusion region, it enables only a single core to enter the critical area at a time.

Thereafter, by the noise source entropy generation unit, it is determined whether one of the plurality of cores has entered the critical area at step S320. If it is determined at S320 that the single core has entered the critical area, control proceeds to step S330. In this case, the identifier of the core that has entered the critical area may be stored in a separate storage unit. Here, if the identifier is previously present in the separate storage unit, a new identifier subsequent to the previously stored identifier may be stored. That is, identifiers of the plurality of cores may be stored in the sequence of entry thereof into the critical area. Of course, this storage procedure may be performed in such a way as to store identifiers in the storage unit either one by one at step S320 or in batch at step S340, which will be described later. Since a description of this procedure has been made in detail with reference to FIG. 1, it will be omitted here. In contrast, if it is determined at step S320 that any core that has entered the critical area is not present, step S320, that is, the procedure for determining whether any one core has entered the critical area, is repeated.

At step S330, by the noise source entropy generation unit, the entry of the remaining cores into the critical area is prevented. As described above, the critical area is a mutual exclusion region, and thus if a single core enters the critical area, the entry of the remaining cores into the critical area is prevented.

Thereafter, by the noise source entropy generation unit, it is determined whether cores capable of entering the critical area are present at step S340. That is, at step S340, it is determined whether cores to enter the critical area remain. If it is determined that cores capable of entering the critical area are present, control proceeds to step S350, otherwise control proceeds to step S370.

At step S350, by the noise source entropy generation unit, one of the remaining cores is selected. Here, the core is randomly selected without being selected using a specific algorithm.

Thereafter, if the core that entered the critical area leaves the critical area, the prevention of entry into the critical area is released at step S360. By step S360, any core selected at step S350 may enter the critical area. Then, control returns to step S320, and thus the above procedures are repeated.

Further, the above-described steps S320 to S360 are performed using a busy waiting lock technique, as described above. That is, the noise source entropy acquisition method according to the present invention selects any one from among the remaining cores, the entry of which is prevented. Accordingly, the present invention is characterized in that, when the prevention of entry into the critical area is released, the selected core is caused to enter the critical area.

At step S370, noise source entropy is generated based on the information stored in the storage unit, that is, the plurality of identifiers stored in the sequence of entry into the critical area. In this way, once the noise source entropy is generated, control proceeds to an end step, and then all control is terminated.

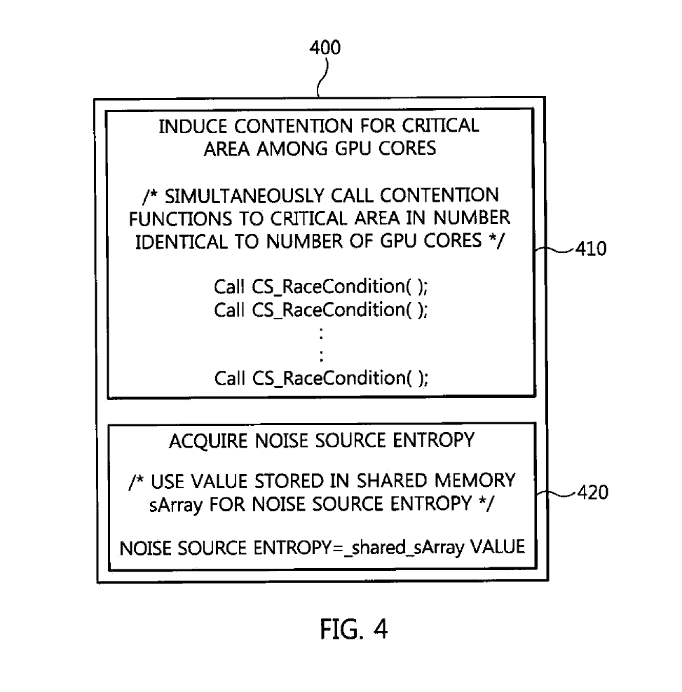

FIG. 4 is a diagram showing code for implementing the noise source entropy acquisition method in the form of a program according to the present invention. That is, the noise source entropy acquisition method according to the present invention may be implemented in the form of a computer program. FIG. 4 illustrates a noise source entropy acquisition function 400 according to the present invention which may be produced in the form of a program.

As described above with reference to FIGS. 1 to 3, the noise source entropy acquisition function 400 may include a part 410 for calling a plurality of cores included in the GPU and a part 420 for storing the values, stored in the storage unit, as noise source entropies. As shown in FIG. 4, the part 410 for calling the plurality of cores simultaneously calls a number of contention functions (CS_RaceCondition ( ) functions) to the critical area, wherein the number of contention functions is identical to the number of GPU cores. Here, the procedure for contending for access to the memory in the GPU may be performed using a kernel function.

In FIG. 4, when the plurality of cores are called, the contention functions may first declare variables and arrays executed in the functions and then initialize the variables and arrays. In this case, the variables may be used to represent the sequence of cores that arrive at the critical area. Further, a number of arrays corresponding to the number of cores are allocated. Accordingly, the arrays may be subsequently used to store the identifiers of cores in the sequence of arrival at the critical area.

That is, as described above with reference to FIG. 3, the sequence of a plurality of cores to the critical area is extracted using a busy waiting lock technique, and the identifiers of the plurality of cores are stored in the respective arrays in the sequence of extraction. By way of this, in the part 420, the noise source entropy may be generated based on the arrays generated using the contention functions.

In accordance with the apparatus and method for acquiring noise source entropy according to the present invention, there is an advantage in that sound noise source entropy forming a seed that is input to a random number generator may be secured.

Further, there is an advantage in that a noise source generated by the noise source entropy acquisition apparatus and method of the present invention forms the input seed of the random number generator, thus guaranteeing the security of output random numbers.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. An apparatus for acquiring noise source entropy for a random number generator, comprising:
a core calling unit for simultaneously calling a plurality of cores to a critical area; and
a noise source entropy generation unit for generating noise source entropy based on a sequence of entry of the plurality of cores into the critical area.

2. The apparatus of claim I wherein the plurality of cores are cores included in a Graphical Processing Unit (GPU).

3. The apparatus of claim 1, wherein the noise source entropy generation unit is configured to, if any one of the plurality of cores enters the critical area, prevent entry of remaining cores into the critical area.

4. The apparatus of claim 3, wherein the noise source entropy generation unit is configured to, if the core that entered the critical area leaves the critical area, release prevention of entry into the critical area.

5. The apparatus of claim 4, wherein the noise source entropy generation unit uses a busy waiting lock technique for selecting any one from among the remaining cores, entry of which is prevented, and causing the selected, core to enter the critical area when prevention of entry into the critical area is released.

6. The apparatus of claim 5, wherein the busy waiting lock technique is repeated until a number of cores to enter the critical area becomes 0.

7. The apparatus of claim 6, wherein the noise source entropy generation unit is configured to store respective identifiers of the plurality of cores in a storage unit in a sequence of entry of the cores into the critical area, and generate the noise source entropy based on the identifiers stored in the sequence of entry of the cores into the critical area.

8. The apparatus of claim 1, wherein the critical area is formed in memory used by the GPU.

9. A method of acquiring noise source entropy for a random number generator, comprising:
simultaneously calling, by a core calling unit, a plurality of cores to a critical area; and
generating, by a noise source entropy generation unit, noise source entropy based on a sequence of entry of the plurality of cores into the critical area.

10. The method of claim 9 wherein the plurality of cores are cores included in a Graphical Processing Unit (GPU).

11. The method of claim 9, wherein generating the noise source entropy is configured to, if any one of the plurality of cores enters the critical area, prevent entry of remaining cores into the critical area.

12. The method of claim 11, wherein generating the noise source entropy is configured to, if the core that entered the critical area leaves the critical area, release prevention of entry into the critical area

13. The method of claim 12, wherein generating the noise source entropy is performed using a busy waiting lock technique for selecting any one from among the remaining cores, entry of which is prevented, and for causing the selected core to enter the critical area when prevention of entry into the critical area is released.

14. The method of claim 13, wherein the busy waiting lock technique is repeated until a number of cores to enter the critical area becomes 0.

15. The method of claim 14, wherein generating the noise source entropy is configured to store respective identifiers of the plurality of cores in a storage unit in a sequence of entry of the cores into the critical area, and generate the noise source entropy based on the identifiers stored in the sequence of entry of the cores into the critical area.

16. The method of claim 9, wherein the critical area is formed in memory used by the GPU.
